(19) United States
(12) Patent Application Publication
(10) Pub. No.: US 2001/0047331 A1
(43) Pub. Date: Nov. 29, 2001

(54) Method for processing remittance payment documents

(76) Inventors: Robert Malanga, Lake Mary, FL (US); Phillip C. Reinke, Woodstock, GA (US); Mark Guglielmi, Westport, CT (US); Ralph Passarelli, Ridgefield, CT (US)

Correspondence Address: CANTOR COLBURN, LLP, 55 GRIFFIN ROAD SOUTH, BLOOMFIELD, CT, 06002

(21) Appl. No.: 09/681,382

(22) Filed: Mar. 27, 2001

Related U.S. Application Data
(60) Provisional application No. 60/192,756, filed on Mar. 28, 2000.

(51) Int. Cl. G06F 17/60

(52) U.S. Cl. 705/40

(57) ABSTRACT

A method for automatically processing remittance payment documents is disclosed. In an exemplary embodiment of the invention the method includes receiving a plurality of payment documents for processing. The contents of the plurality of payment documents are then imaged and recorded to extract data contained thereon, the data being used for remittance processing. An attempt is then made to match the extracted data with a particular known account and known account holder. If the extracted data is matched with the known account and known account holder, then a payment amount included within the extracted data is then processed. If the extracted data is not matched with the known account and known account holder, then the extracted data is forwarded to a learning process and stored in a database prior to the processing of the payment amount included within the extracted data.

### CROSS REFERENCE TO RELATED APPLICATIONS

This application claims the benefit of U.S. provisional patent application serial No. 60/192,756, filed Mar. 28, 2000, the entire contents of which are incorporated herein by reference.

### BACKGROUND OF INVENTION

Remittance payment processing can be a complicated task involving numerous sub-processes that route and treat each transaction based on its individual payment characteristics. For example, transactions may be characterized and sorted based upon whether they are “payment in full” transactions, “minimum payment” transactions, or “miscellaneous payment” transactions. As a result of these complexities, payment processing is typically manually intensive and susceptible to inefficiencies and errors. As a business grows, significant increases in operating capacity cannot be realized without corresponding increases in personnel, equipment and associated costs therewith.

The “kill” rate in the field of remittance processing refers to the percentage of payment transactions that are automatically posted without human intervention. For existing methods of remittance payment processing, it is estimated that the “kill” rate is in the neighborhood of 20%. Put another way, roughly 70% to 80% of remittance payment processing requires some form of human intervention from the time of the initial mail extraction to the time that the payment is posted. Such human intervention increases operating costs, as well as the overall chance for processing errors.

### SUMMARY OF INVENTION

The above discussed and other drawbacks and deficiencies of the prior art are overcome or alleviated by a method for automatically processing remittance payment documents. In an exemplary embodiment of the invention the method includes receiving a plurality of payment documents for processing. The contents of the plurality of payment documents are then imaged and recorded to extract data contained thereon, the data being used for remittance processing. An attempt is then made to match the extracted data with a particular known account and known account holder. If the extracted data is matched with the known account and known account holder, then a payment amount included within the extracted data is then processed. If the extracted data is not matched with the known account and known account holder, then the extracted data is forwarded to a learning process and stored in a database prior to the processing of the payment amount included within the extracted data.

In a preferred embodiment, the plurality of payment documents are received within an envelope. The method further includes imaging and storing information contained upon the envelope. The payment documents further include a remittance stub and a check. The extracted data further includes: a bank code included on the check, a remittance payment amount included on the remittance stub, and a signature included on the check. The handwritten data on the check is read by optical character recognition equipment and by handwriting analysis software, while the bank code on the check is read by a microcode reader.

### BRIEF DESCRIPTION OF DRAWINGS

Referring to the exemplary drawings wherein like elements are numbered alike in the several Figures:

FIG. 1 is a flow diagram illustrating an existing remittance payment processing system;

FIG. 2 is a block diagram of a method for processing remittance payment documents, in accordance with an embodiment of the invention; and

FIG. 3 is a block diagram illustrating an alternative embodiment of the method shown in FIG. 2.

### DETAILED DESCRIPTION

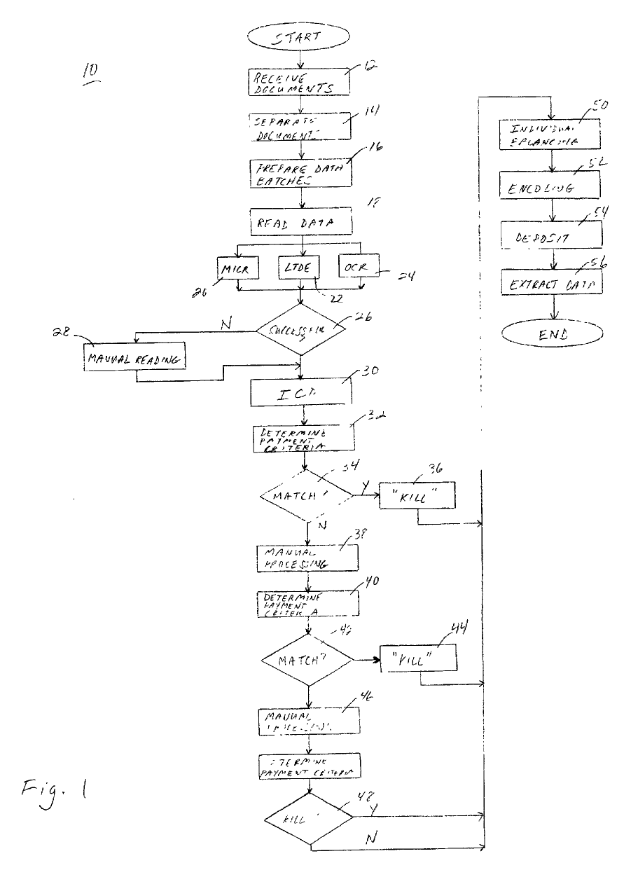

Referring initially to FIG. 1, an existing method 10 of remittance payment processing is illustrated. The documents to be processed are received in a mailroom at block 12, after which the documents are then forwarded to an automated document separation process at block 14. At that point, each payment envelope is opened and the payment stub (or coupon) contained therein is separated from the remittance (check), as well as from any other miscellaneous documents that may be enclosed within the envelope. Approximately 85% of the envelopes received are standard remittance envelopes, i.e., size 8 envelopes. A standard remittance envelope contains a single check and a payment coupon or stub. Document separation process 14 then orients the documents by placing the check on top of the payment stub or coupon. Any miscellaneous documents contained within the envelope are thereafter removed and set aside for manual review. However, if the payment stub is missing, the check itself is set aside for manual review.

After all envelopes have been opened and the contents therein are sorted, method 10 proceeds to a data preparation process at block 16. Data preparation process 16 then places matching pairs of payment stubs and checks into trays, thereby creating a data batch. Each batch typically contains approximately 200 payment stub/check pairs, with each individual batch being separated by a lead ticket for data entry identification. Once the batches are created, method 10 proceeds to block 18, where a data reading process is implemented for each stub/check pair. The data reading process 18 features three separate data readers, including a microcode reader (MICR) 20, a lead ticket data reader (LTDE) 22 and an optical character reader (OCR) 24.

The MICR 20 attempts to read the bank microcode on each check. As is known, the bank microcode contains bank identification and bank account number information on each check. The microcode is typically printed with special ink, which can be magnetized for automatic reading. The LTDE 22 reads the lead ticket data contained on each lead ticket for a given batch. Finally, the OCR 24 reads the information contained on the payment stub (e.g., credit card account number, minimum payment due, etc.), as well as the courtesy amount printed on the check. The courtesy amount printed on a check is the numerical amount, as opposed to the legal amount written in words.

If any of the three readers are unable to read their corresponding data, as determined at decision block 26, then a manual reading (repair function) is implemented at block 28. For example, if the OCR were unable to read the courtesy amount on a particular check, then a human operator would read the amount on the check and manually enter it into the system. On the other hand, those stub/check pairs that are successfully read by data reading process 18 proceed to block 30, where an intelligent character recognition process (ICR) is implemented. The ICR process 30 typically includes software such as CAR (Courtesy Amount Recognition) and LAR (Legal Amount Recognition) software that recognizes and processes the data read by the readers described above.

Once the ICR process 30 is completed for a batch (and/or individual repairs are entered manually), method 10 proceeds to a first payment criteria determination at block 32. The first payment criteria determination verifies whether or not the payment amount from a stub/check pair matches one of the following criteria: “Full Payment”, wherein the amount remitted equals the full amount due; “Minimum Payment”, wherein the amount remitted equals the minimum payment due; “Scheduled Payment”, wherein the amount remitted equals an amount due under an agreed scheduled payment (typically used in credit counseling situations); and “Last Payment”, wherein the amount remitted is equal to an amount habitually paid by a customer with each statement. Each stub-check pair in a given batch is compared to these four payment criteria. At decision block 34, if it is determined that every stub/check pair in a given batch matches up with one of the four criteria, then the batch is considered a “kill” at block 36. A “kill” in this instance means that a sub-process was executed in a fully automated manner with no manual intervention. If the batch is a “kill” at this point, method 10 proceeds to block 50 for final processing, as described later. However, it is typically the case that only about 23% of batches processed will qualify as “kills” at this particular stage of method, given the large amount of stub/check pairs and the fact that just a single mismatch prevents the batch from qualifying as a “kill”.

As is more likely, if any stub/check pair does not meet one of the four payment criteria described above, the entire batch is sent to a manual keystroke process (Auto Key System) at block 38. At this point, the courtesy amounts for each check are visually checked and manually entered. The batches are passed onto a second payment criteria determination at block 40. In the second payment criteria determination, the stub/check pairs are once again put through the four-inquiry test described above. If all stub/check pairs then meet one of the four criteria, determined this time at decision block 42, the batch is considered a “kill” at block 44 and is sent for final processing at block 50. Typically, the percentage of batches that qualify as a “kill” at this point increases to approximately 66%, but at the cost of human intervention. In the event that a batch still does not meet one of the four criteria, method 10 may proceed to another manual process at block 46. This time, another manual keystroke process 46 may include a comparison of the courtesy amount and the legal amount on the check. If all the stub/check pairs then meet one of the four criteria, the batch is considered a “kill” at block 48.

Regardless of whether the batch is considered a “kill” after manual processing, method 10 eventually proceeds to final processing beginning at block 50. Up to this point, all of the processing in method 10 is based solely upon the data contained on the check. A human operator performs an individual balancing (IBAL) function, wherein a decision is made as to whether an individual transaction is a valid one based upon the information on the check and the stub. After completing the IBAL process, method proceeds to block 52, where a batch of completely matched stub/check pairs is passed on to an encoding process. Encoding process 52 applies an endorsement to each check, as well as other processing information such as the American Banking Association Routing number. The batches are validated as they pass through the encoding process 52. A deposit process is then implemented at block 54, wherein a deposit slip or cash letter is created for each batch. Finally, data from each batch is extracted to provide information to, for example, a credit card account at block 56. An individual credit card account is only credited after a deposit slip has been created, with each individual deposit slip then being manually verified.

It can be seen from the foregoing description, therefore, that the existing method 10 of remittance payment processing, although automated at certain points, requires a significant amount of human intervention.

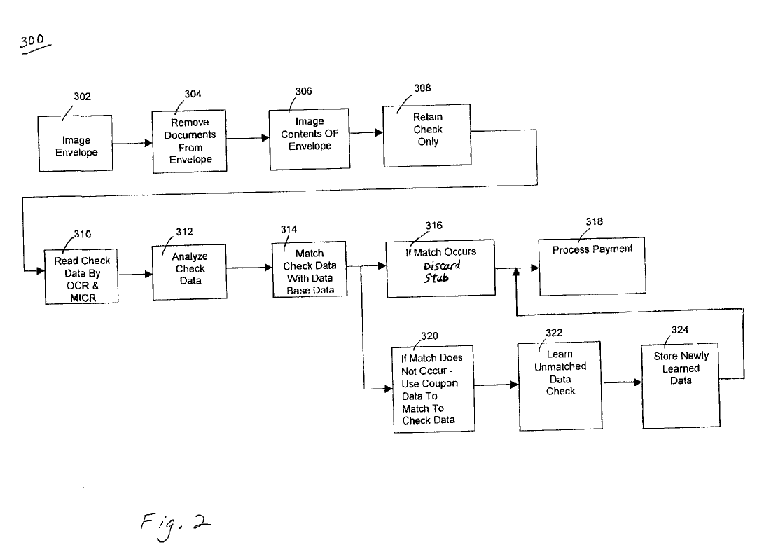

Accordingly, an embodiment of the invention disclosing a method 300 of processing documents, so as to reduce the need for human invention, is shown in FIG. 2. Initially, the remittance documents are received within individual envelopes. Each envelope is then visually imaged by electronic camera or other suitable recording device at block 302 for recording of information contained thereon. One element of important information on the envelope may be the postmark. Because late fees are one major revenue source for a credit card organization, for example, the postmark is a beneficial piece of information associated with resolving late fee disputes. In addition, a return address included on the remittance envelope may also be a source for change of address information. An additional piece of information may be included within the window of most remittance envelopes.

The next step in method 300 is the removal of the remittance documents from the envelope at block 304. Following removal, the image of each side of an item contained within an envelope is taken by a camera or other imaging device at block 306. If an envelope contains items other than a check and a remittance stub, then the contents therein are saved for a manual review. Otherwise, only the check is retained for further processing at block 308. Next, optical character recognition (OCR) equipment and a microcode reader (MICR) read the data contained on the check at block 310. The check data, including relevant handwritten entries thereon, are analyzed by a set of reader engines and interpretive software at block 312. The data analyzed includes the Courtesy Amount, the Legal Amount, the signature line and the data on microcode line. Again, the microcode line data includes the bank identifier and the bank account number. The interpretative software is used to analyze the handwriting on the check in order to determine the identity of the signer and the characteristics of the signer's handwriting.

At block 314, the microcode data and the handwriting data are used to match the particular remittance to a specific bank account and an individual with a credit card account. An attempt is then made to match the check data (including identity of the check issuer, the credit card account and the amount of the check) with data on file in a database. If the identity of the check is positively matched with a credit card account, the remittance stub is discarded at block 316 and method 300 proceeds to block 318 for processing of the payment, as is discussed more fully hereinafter. Multiple character recognition engines may be used to account for the fact that some imaged data characters could be in cursive format, while other data characters may be in printed format.

From a pure processing point of view, the check could also be disposed of, in addition to the remittance stub. However, banking authorities still require a hard copy of the check to be processed within the banking channels. In the event that banking regulations are eventually modified so as to permit the processing of the data on the checks from the imaged checks, the checks can be disposed of at this point of method 300. For the purposes of the present processing requirements, then, the checks are retained in order to properly process the hard copies thereof.

If a match does not take place between the check data and data already on file in a database, the signature data and the other check data are forwarded to a learning process, beginning at block 320, along with the imaged data from the remittance stub. The learning process determines the relationship between handwritten signature characteristics and known data about the account holder at block 322. The learning process preferably includes artificial intelligence techniques, such as neural networks and Bayesian theory, to study and learn the unique characteristics of the handwriting samples. Even if manual intervention is required, the learning process captures the results therefrom, as well as from the automated results.

Newly learned data is then stored in the existing database and an account holder data file is created at block 324. The account holder data file includes the account holder's signature profile along, with the corresponding bank account number and credit card account number. In storing the results of both automated data capture and manual intervention, the learning process first looks to the captured data before determining a new manual intervention is needed. Therefore, any future checks received from a particular individual will thereafter increase the probability of creating a data match as discussed above. After the newly learned data is stored, the check data (including the account holder's identity, the bank account number, the credit card number and the amount of payment) are then forwarded for payment processing at block 318.

With the use of handwriting recognition software, the processing of remittance payments may be carried out on an individual basis rather than by a batch basis, as described above in existing method 10. However, with method 300, the remittances may ultimately be batched after processing in order to forward the processed payments in a more convenient form for external banking.

Referring again to block 318, once the data is read from the check and the identity of the bank account and credit card have finally been established, method 300 can then process the amount of the payment. The Courtesy Amount data and Legal Amount data that have been read in by OCR and MICR processes at block 310 are used to establish the amount of the payment. If any of the payment amount data is unreadable by the OCR and MICR processes, the handwriting recognition software used at block 314 in the matching process may also used to determine the payment amount values. Once the payment amount value is determined, it is then compared with the amount due. As noted earlier, there are four categories useful in remittance payment processing: “Full Payment” “Minimum Payment” “Scheduled Payment” and “Last Payment”.

As is also noted earlier, if the payment amount does not equal one of the four described criteria, the remittance process is then subject to human intervention. However, because the ability to accurately determine the correct remitted amount has been enhanced by the handwriting interpretation software and OCR software, any such amount can be processed for credit and forwarded to a bank processing system. In the event that the amount written in on the Legal Amount line is inconsistent with the amount written of the Courtesy Amount Line, then the amount on the Legal Amount line will prevail. In additionally, method 300 will have the payment history of the credit card account holder for use in an evaluation. If the account holder has a history of paying the full amount on all the payments and there is a small discrepancy between the Legal Amount line and the actual full payment, the system may make certain probabilistic presumptions about the correct amount to credit the account.

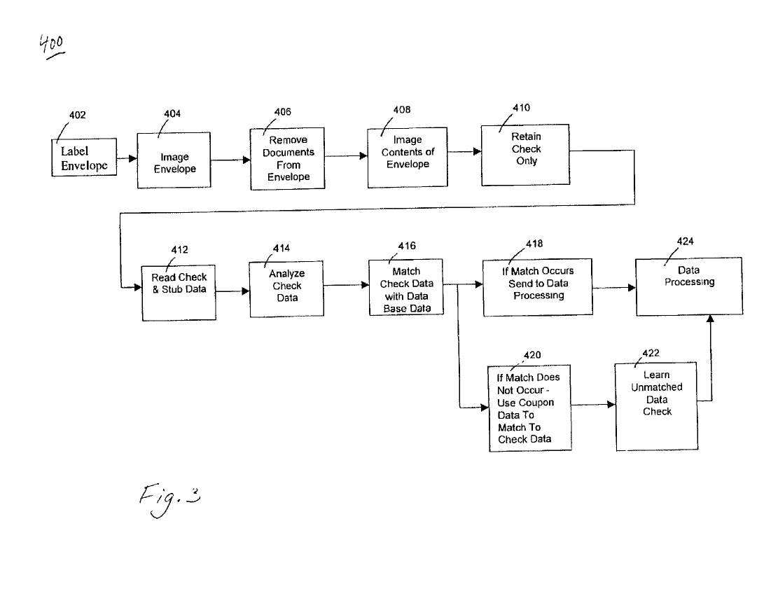

An alternative embodiment of a method 400 for processing remittance payments is illustrated in FIG. 3. Method 400 begins at block 402, where remittance documents received in individual envelopes, which are labeled with an identifier. Again, in existing remittance processing methods, the envelopes are opened and the remittance documents therein are placed in batches with an exemplary quantity of 200 remittances per batch. In lieu of a lead ticket, method 400 uses a unique payer identification identifier (UPII). The UPII is applied to each envelope and is thereafter associated with an individual envelope, as well as all documents included within an envelope. Both sides of the envelope are then imaged for recording information thereon at 404. Blocks 406 through 416 of method 400 are analogous to blocks 304 through 314 of method 300.

From the foregoing description, it will be seen that the key to the improvement of the document processing is the combination of improved intelligent character recognition and the use of learning techniques used in artificial intelligence systems. These learning systems include neural networks and Bayesian learning networks. The illustrated embodiments of the invention use a handwriting recognition system that does not depend upon established algorithms. Individual handwriting samples are studied and certain patterns are associated with certain individuals. As method 300, 400 sees repetitive scans of a particular handwriting sample, it will recognize that the documents have originated from Mr. Jones versus Ms. Smith. Based upon the learning of associating a particular handwriting, method 300, 400 learns to whom and what account a particular remittance can be associated in order to improve the speed and accuracy of associating a particular check or other document with an individual or account. Furthermore, the interpretation of the amount remitted need not be limited to the pre-established payment criteria described earlier. With the increased confidence associated with the character recognition software, any amount may be captured and processed. If a remittance cannot be automatically analyzed for processing, method 300, 400 will learn from the rejection in order to avoid a duplicate rejection thereafter.

The present invention can be embodied in the form of computer-implemented processes and apparatuses for practicing those processes. The present invention can also be embodied in the form of computer program code containing instructions, embodied in tangible media, such as floppy diskettes, CD-ROMs, hard drives, or any other computer-readable storage medium, wherein, when the computer program code loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When the implementation on a general-purpose microprocessor, the computer program code segments configure the microprocessor to create specific logic circuits.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited, but that the invention will include all embodiments falling within the scope of the appended claims.

1. A method for automatically processing remittance payment documents, the method comprising:
receiving a plurality of payment documents for processing;
imaging and recording the content of said plurality of payment documents to extract data contained thereon, said data used for remittance processing;
attempting to match said extracted data with a particular known account and known account holder;
processing a payment amount included within said extracted data, if said extracted data is matched with said known account and known account holder; and
if said extracted data is not matched with said known account and known account holder, then forwarding said extracted data to a learning process and storing said extracted data in a database prior to processing said payment amount included within said extracted data.

2. The method of claim 1, wherein said plurality of payment documents are received within an envelope.

3. The method of claim 2, further comprising imaging and storing information contained upon said envelope.

4. The method of claim 3, wherein said envelope includes a unique payer identification identifier attached thereto.

5. The method of claim 1, wherein said payment documents comprise credit card payment documents.

6. The method of claim 2, wherein said credit card payment documents further comprise a remittance stub and a check.

7. The method of claim 6, wherein said extracted data further comprises:
a bank code, said bank code included on said check;
a remittance payment amount, said remittance payment amount included on said remittance stub; and
a signature, said signature included on said check.

8. The method of claim 7, wherein handwritten data on said check is read by optical character recognition equipment.

9. The method of claim 8, wherein said handwritten data on said check is analyzed by handwriting analysis software.

10. The method of claim 7, wherein said bank code on said check is read by a microcode reader.

11. A storage medium encoded with a machine readable computer program code for automatically processing remittance payment documents, the storage medium including instructions for causing a computer to implement a method, the method comprising:
receiving a plurality of payment documents for processing;
imaging and recording the content of said plurality of payment documents to extract data contained thereon, said data used for remittance processing;
attempting to match said extracted data with a particular known account and known account holder;
processing a payment amount included within said extracted data, if said extracted data is matched with said known account and known account holder; and
if said extracted data is not matched with said known account and known account holder, then forwarding said extracted data to a learning process and storing said extracted data in a database prior to processing said payment amount included within said extracted data.

12. The storage medium of claim 11, wherein said plurality of payment documents are received within an envelope.

13. The storage medium of claim 12, further comprising imaging and storing information contained upon said envelope.

14. The storage medium of claim 13, wherein said envelope includes a unique payer identification identifier attached thereto.

15. The storage medium of claim 11, wherein said payment documents comprise credit card payment documents.

16. The storage medium of claim 12, wherein said credit card payment documents further comprise a remittance stub and a check.

17. The storage medium of claim 16, wherein said extracted data further comprises:
a bank code, said bank code included on said check;
a remittance payment amount, said remittance payment amount included on said remittance stub; and
a signature, said signature included on said check.

18. The storage medium of claim 17, wherein handwritten data on said check is read by optical character recognition equipment.

19. The storage medium of claim 18, wherein said handwritten data on said check is analyzed by handwriting analysis software.

20. The storage medium of claim 17, wherein said bank code on said check is read by a microcode reader.

21. A computer data signal for automatically processing remittance payment documents, the computer data signal comprising code configured to cause a processor to implement a method, the method comprising:
receiving a plurality of payment documents for processing;
imaging and recording the content of said plurality of payment documents to extract data contained thereon, said data used for remittance processing;
attempting to match said extracted data with a particular known account and known account holder;
processing a payment amount included within said extracted data, if said extracted data is matched with said known account and known account holder; and
if said extracted data is not matched with said known account and known account holder, then forwarding said extracted data to a learning process and storing said extracted data in a database prior to processing said payment amount included within said extracted data.

22. The computer data signal of claim 21, wherein said plurality of payment documents are received within an envelope.

23. The computer data signal of claim 22, further comprising imaging and storing information contained upon said envelope.

24. The computer data signal of claim 23, wherein said envelope includes a unique payer identification identifier attached thereto.

25. The computer data signal of claim 21, wherein said payment documents comprise credit card payment documents.

26. The computer data signal of claim 22, wherein said credit card payment documents further comprise a remittance stub and a check.

27. The computer data signal of claim 26, wherein said extracted data further comprises:
a bank code, said bank code included on said check;
a remittance payment amount, said remittance payment amount included on said remittance stub; and
a signature, said signature included on said check.

28. The computer data signal of claim 27, wherein handwritten data on said check is read by optical character recognition equipment.

29. The computer data signal of claim 28, wherein said handwritten data on said check is analyzed by handwriting analysis software.

30. The computer data signal of claim 27, wherein said bank code on said check is read by a microcode reader.
